(19) United States
(12) Patent Application Publication
(10) Pub. No.: US 2016/0008231 A1
(43) Pub. Date: Jan. 14, 2016

(54) Pacifier Holder and Stand

(71) Applicant: Ronni Peck, Burbank, CA (US)

(72) Inventor: Ronni Peck, Burbank, CA (US)

(21) Appl. No.: 14/794,528

(22) Filed: Jul. 8, 2015

Related U.S. Application Data
(60) Provisional application No. 62/021,834, filed on Jul. 8, 2014.

(51) Int. Cl. A61J 17/00

(52) U.S. Cl. CPC A61J 17/00

(57) ABSTRACT

A combined pacifier holder and stand whereby the pacifier is attached to a stand and held in an ‘at the ready’ position for an infant to retrieve and spit out on their own. The top of the stand attaches to a pacifier to hold it near the infant's mouth. The bottom of the stand connects to a base that separately fastens to an infant's clothing, blanket, toy, or other infant item. The stand is made of a sturdy, flexible material such that it can bend and twist as the infant moves its head from side to side.

### CROSS-REFERENCE TO RELATED APPLICATIONS

This application claims the benefit of provisional patent application Ser. No. 62/021,834, filed 2014 Jul. 8 by the present inventor, the above provisional application is incorporated by reference herein.

### BACKGROUND

Babies are often comforted by the non-nutritive sucking of a device known as a pacifier, dummy, or soother. Many infants require the use of a pacifier in order to soothe themselves or to help themselves sleep.

U.S. Pat. No. 4,969,894 to Hempstead-Harris (1989) is for an apparatus that attaches to a baby's ears and holds the pacifier in an infant's mouth. U.S. patent application 20,090,013,449 submitted by Khan (2009) is for a hat that uses strings to hold a pacifier in an infant' mouth. Both these methods are potentially dangerous. Forcibly holding a pacifier in an infant's mouth could result in suffocation or asphyxiation.

Several other prior art examples, such as U.S. Pat. No. 5,593,336 to Thomas (1997), U.S. Pat. No. 4,697,589 to King (1987), U.S. Pat. No. 5,344,355 to Silverstein (1994), U.S. Pat. No. 5,908,439 to Ford and Vineyard (1997), U.S. Pat. No. 8,745,794 to McDermott (2010) and U.S. Pat. No. 6,292,962 to Dunn and Fine (1998) show a soft weighted object such as a blanket, toy, or stuffed animal attached to a pacifier and placed on an infant's chest. U.S. Pat. No. 7,725,954 to Delprete (2007) shows a pacifier holding device that attaches to a child's clothing that would not fall off an infant's chest with a position change

U.K. patent application 0,262,199 submitted by Krols (1988) initially appears to propose a solution with a devise that both attaches to an infant's clothing and holds a pacifier right next to a baby's mouth, allowing the infant to spit out and re-insert a pacifier by themselves.

### BRIEF DESCRIPTION OF THE DRAWINGS

In the drawings, closely related figures have the same number but different alphabetic suffixes.

FIG. 1A shows an embodiment of a pacifier stand base attached to a child's clothing with a pacifier and stand held upright so that the pacifier is held up to a child's mouth.

FIG. 1B shows an embodiment of a pacifier stand base attached to a child's clothing without a pacifier stand connected.

FIG. 2 shows a front perspective of an embodiment of a pacifier stand connected to a base with a pacifier attached and held in an at-the-ready position for an infant to use.

FIG. 3A is a left front perspective of an embodiment of a fold over base and connected stand.

FIG. 3B is a left front perspective of an embodiment of a fold over base with fasteners to connect a pacifier stand.

FIG. 3C is a left front perspective of an embodiment of a pacifier stand.

FIG. 4A is a back perspective of the top of a pacifier stand with a pacifier attached to a stand with a pacifier attachment strap.

FIG. 4B is a front perspective of the top of a pacifier stand with a pacifier attached to a stand with a pacifier attachment strap.

FIG. 4C is a left front perspective of an embodiment of the top part of a pacifier stand with a pacifier held in place against the stand with a pacifier attachment strap.

FIG. 5A is a left front perspective of an embodiment of a fulcrum.

FIG. 5B is a left front perspective of an embodiment of a fulcrum adjustingly attached to a pacifier stand base connected to a base.

FIG. 6 shows an infant wrapped in a blanket with an embodiment of a pacifier stand base folded over and fastened to a blanket.

FIG. 7 shows an infant being held at a slight incline and an embodiment of a pacifier stand holding a pacifier not currently in use by the infant but held in an at-the-ready position.

Drawings - Reference Numerals

| | | | |
|---|---|---|---|
| 11 | detachable pacifier stand | 41 | adjustable pacifier attachment |
| 12 | stand base | | back |
| 21 | base fastener | 42 | adjustable pacifier attachment |
| 31 | stand base back | | front right |
| 32 | fold over connector | 43 | adjustable pacifier attachment |
| 33 | stand base front | | front left |
| 35 | upper stopper notch | 51 | fulcrum |
| 36 | upper stand section | 52 | fulcrum cutout |
| 38 | lower stopper notch | 81 | pacifier front |
| 310 | stand attachment panel | 82 | pacifier back |
| 311 | stand attachment fastener | 83 | pacifier back button nub |
| 312 | stand attachment connecter | 84 | pacifier nipple |
| | back | | |

### DETAILED DESCRIPTION

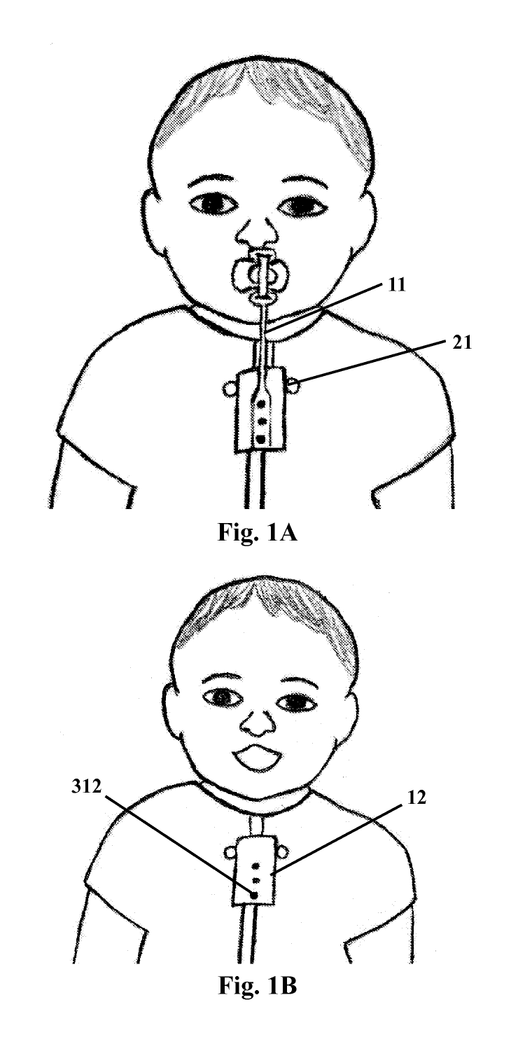

FIG. 1A and FIG. 1B show a front perspective of an embodiment while in use by an infant. A stand base 12 is fastened to a child's clothing through the use of a base fastener 21 which may be constructed in a manner that allows for variation in the fastening method. One embodiment of the base fastener 21 is through the use of clips. The base 12 is constructed of a study, semi-rigid material, with flexibility to adapt comfortably to an infant's movement.

In FIG. 1A, a detachable pacifier stand 11 is attached to stand base 12. The pacifier stand 11 is constructed of a sturdy, flexible material protruding upward so that the top of the stand 11 will securely hold a pacifier near the infant's mouth.

FIG. 1B shows the present embodiment of the base 12 fastened to a child's clothing when the stand 11 is not connected. One or more stand connector back(s) 312 may remain on the base when the stand 11 is not attached.

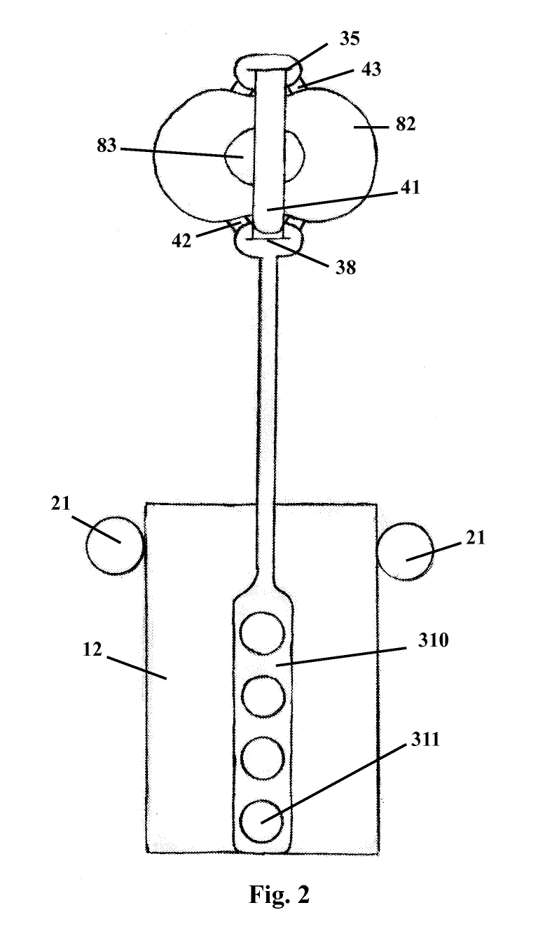

FIG. 2 shows a front perspective of the present embodiment of the pacifier stand 11 securely attached at the upper end to a pacifier and connected at the lower end to the stand base 12. The pacifier stand 11 is detachably connected to the base 12 by a stand attachment panel 310 in a manner that allows for variation in the connecting method. One embodiment of a stand attachment connecter 311 is through the use of snaps.

The upper end of stand 11 securely holds a pacifier through the use of an adjustable pacifier attachment, which is comprised of a back 41, a front right 42, and a front left 43 piece. The adjustable pacifier attachment is made of a sturdy, thin, flexible material which threads through an upper stopper notch 35 and a lower stopper notch 38 to adjustingly tighten at the back 41. The pacifier attachment holds a pacifier back button nub 83 against an upper stand section 36 so that a pacifier back 82 can be seen from a front perspective of the embodiment.

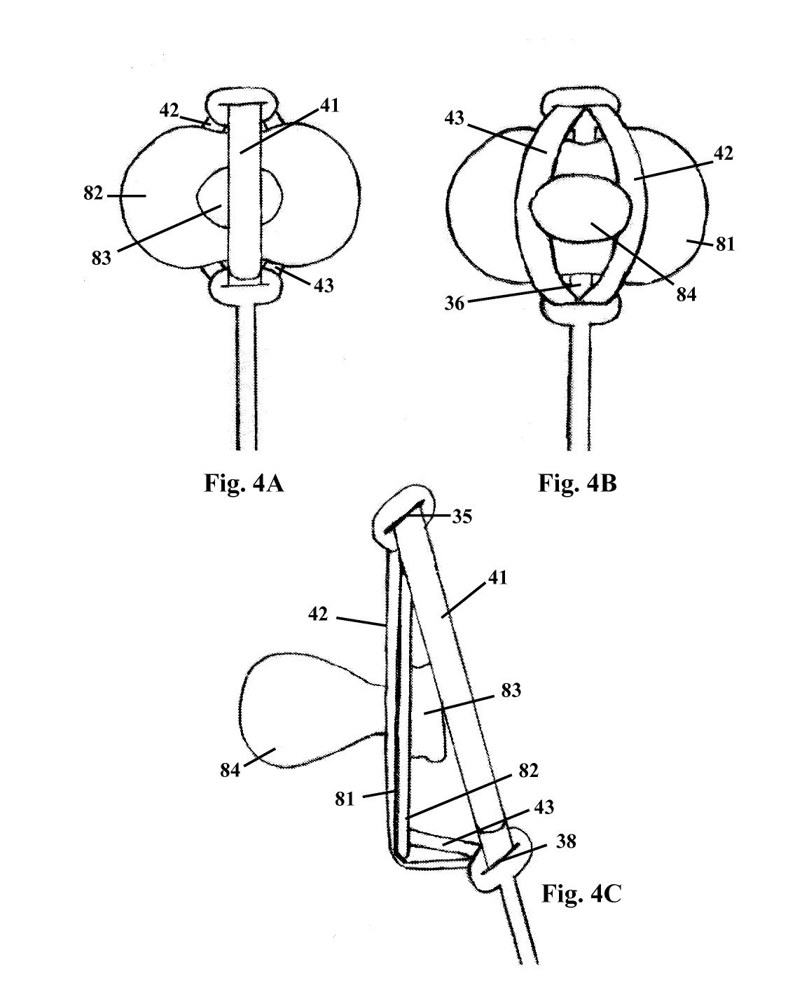

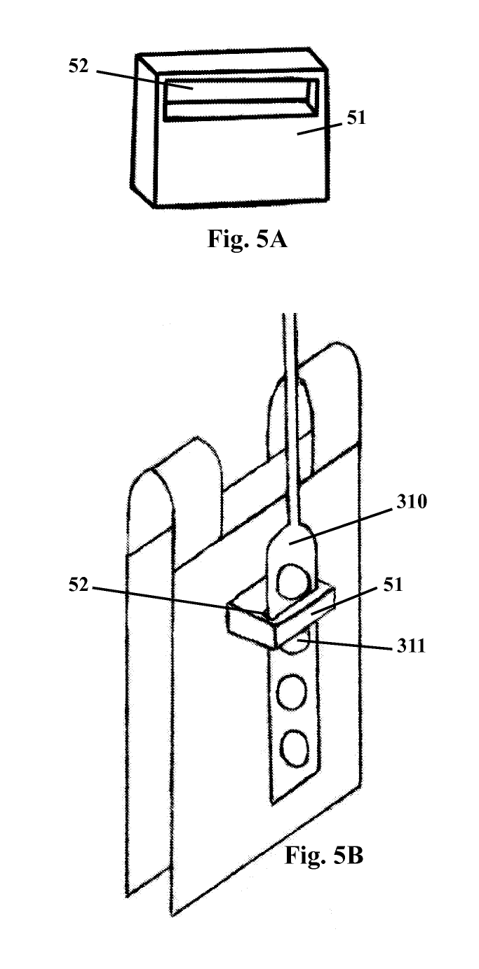

FIG. 4B shows a front perspective of the upper portion of stand 11 with a pacifier securely held in place by the front right 42 and left 43 pacifier attachment straps. The pacifier attachment straps 42 and 43 lie over a pacifier front 81 and allow a pacifier nipple 84 to protrude out from stand 11 at a convenient and flexible position for an infant to retrieve.

Referring to FIGS. 1A, 2, 4A-4C, and 7, the manner of using the present pacifier stand and holder embodiment consists of fastening the stand base 12 to a child's clothing or other item, securing a pacifier to the upper portion of the stand 11 with the adjustable pacifier attachment back 41 and sides 42 and 43, and connecting the detachable pacifier stand 11 to the base 12.

The stand base 11 can be attached to a child's clothing, blankets, car seat or stroller straps, or other toy or infant item through the use of a base fastener 21. The base fastener 21 may be constructed in a manner that allows for variation in the fastening method. The base 12 is constructed of a study, semi-rigid material, with flexibility to adapt comfortably to an infant's bodily or clothing movements. The base 12 may be left fastened to an infant's clothing or blanket with or without the stand 11 attached when it is not in use.

To secure a pacifier to the upper portion of the stand 11, one must first thread the back ends 41 of the pacifier attachment through the upper 35 and lower 38 stopper notches and secure the back ends 41 together. Then one slides the right side of the pacifier front 81, under the front right of the pacifier attachment 42 so that the pacifier nipple 84 is facing away from the upper stand section 36. The left side of the pacifier front 81 is then inserted under the left front pacifier attachment 43.

After the pacifier is securely attached to the upper portion of the stand 11, the stand attachment panel 310 is connected to the base 12 at the stand attachment connecter back 312. The stand attachment fasteners front 311 and back 312 connect in a manner that allows for variation in the connecting method. The placement of the stand attachment panel 310 can be adjusted in order to allow the proper height for the infant.

FIG. 7 shows an infant being held at a slight incline with and the present embodiment attached to but not currently in use by the infant. The pacifier nipple 84 is held in an at-the-ready position near the mouth for the infant to retrieve as desired.

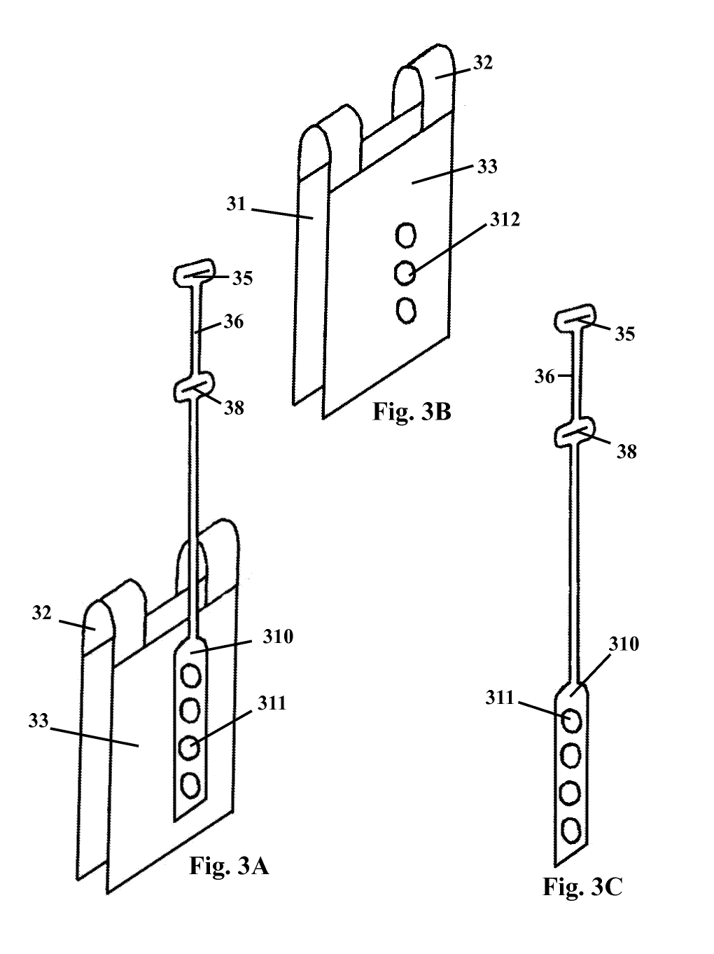

There are various possibilities with regard to the base attachment method and manner of stand placement and adjustment. FIGS. 3A and 3B show a base divided into both a base front 33 and base back 31. The front 33 and back 31 are connected by a flexible fold over connector 32. The base back 31 slips under the front of an infant's clothing or blanket and presses against the front base 33, sandwiching in between a layer of clothing or fabric. The front 33 and back 31 bases are held together in a manner that allows for variation in the securement method. One possible embodiment of a securement method is through the use of magnets. Another possible embodiment of a securement method is through the use of interlocking parts.

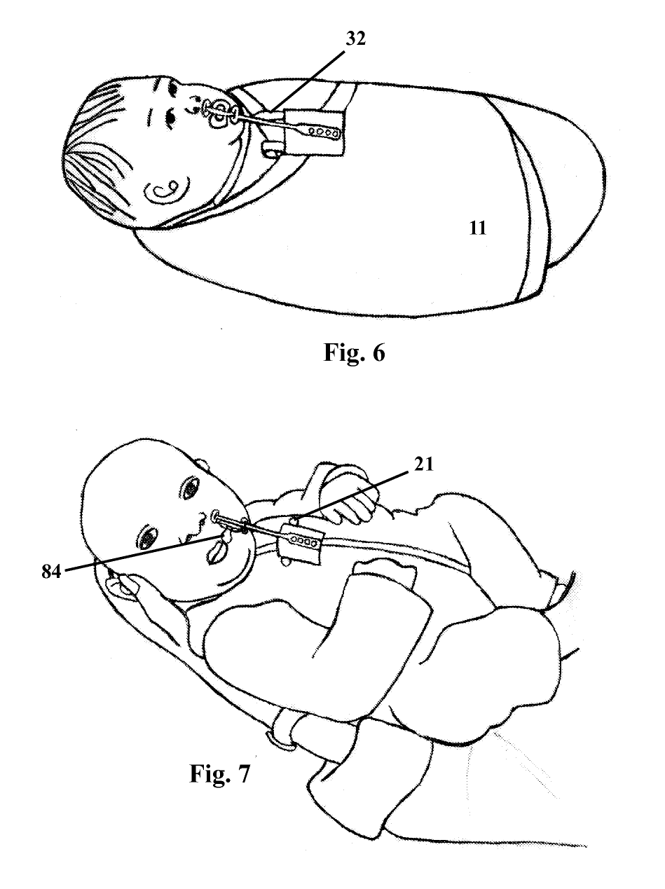

FIG. 6 shows a possible embodiment of a connecting front 33 and back 31 base with a fold over connector 32 folding over the top of an infant's blanket.

FIG. 5A shows a fulcrum 51 that slidingly attaches to the stand attachment panel 310. The fulcrum 51 is made of a sturdy material with a cutout 52 that encircles the stand attachment panel 310 as shown in FIG. 5B. The fulcrum 51 slidingly adjusts the angle of the stand and how high the pacifier is held above the infant's mouth.

I claim:

1. An infant item comprising:
a detachable pacifier stand configured to be coupled to a pacifier;
a stand base configured to be coupled to the detachable pacifier stand by one or more stand attachment fasteners;
one or more base fasteners configured to couple the stand base to an article of clothing;
wherein the detachable pacifier stand is configured to hold the pacifier in a substantially upright position so that it can be substantially close to a mouth of a child.
